(19) United States
(12) Patent Application Publication
(10) Pub. No.: US 2010/0229182 A1
(43) Pub. Date: Sep. 9, 2010

(54) LOG INFORMATION ISSUING DEVICE, LOG INFORMATION ISSUING METHOD, AND PROGRAM

(75) Inventors: Yuji Ito, Fukuoka (JP); Akihiro Kodama, Fukuoka (JP); Takeshi Miyaura, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/683,667

(22) Filed: Jan. 7, 2010

(30) Foreign Application Priority Data
Mar. 5, 2009 (JP) 2009-052238

(51) Int. Cl. G06F 9/44

(52) U.S. Cl. 719/314

(57) ABSTRACT

A log information issuing device includes a priority information manager in which priority information is stored, a priority of a log message being defined in the priority information, a message queue that has a plurality of queues for storing the log message according to the priority, a message sorting processor that refers to the priority information to store the log message in the message queue, an internal resource information collector that determines a load state of an internal resource from operating information on the internal resource, a log message queue processor that takes out the log message from the message queue, the log obtaining condition defining a condition of the log message is taken out from the message queue according to the load state, and a log processor supplies the log message as the log information, the log message being taken out by the log message queue processor.

### CROSS-REFERENCE TO RELATED APPLICATIONS

This application is based upon and claims the benefit of priority of the prior Japanese Patent Application No. 2009-52238, filed on Mar. 5, 2009, the entire contents of which are incorporated herein by reference.

### BACKGROUND

1. Field

The disclosed embodiment relates to a device that issues log information used in cause analysis or an audit trail.

2. Description of the Related Art

In operational management of IT (Information Technology) system, emphasis is placed on cooperation with service business to which a cause analysis or an audit trail is supplied while processing in an easy-to-understand mode. Telnet, SNMP (Simple Network Management Protocol), and syslog (log function) can be cited as an example of a protocol that is useful in monitoring devices constituting the system. A log function that notifies an operation manager of an operating state of the device or information on an error as syslog or retains the operating state or the information in the device is frequently used in the actual system.

The information that is generally issued as a log is frequently correlated with abnormality or trouble generation. Additionally, in order to perform cause analysis in the trouble generation or to confirm a behavior of the device or a whole system, it is necessary to obtain the information on how to operate a functional module or what packet is passed as a log. That is, in order to expose a problematical point of the system, it is necessary to enrich both quantity and quality of the log.

For example, when packet passing information is recorded as the log, a large amount of logs are issued in proportional to an increase in communication amount in a data relay device, such as a router, a fire wall, and a load balancer, which constitutes the IT system. The processing for issuing the log is performed by a CPU or a memory resource in the device, and access to a storage medium is obtained to retain the log. Therefore, the increase in the amount of log issues presses these resources to have an influence on other functions such as data relay, which generates a problem in that communication performance is degraded.

For example, there has been proposed a digest method in which a number of issues of the same logs is supplied for a given time in order to process a large amount of logs without affecting the resources. However, in the digest method, there is a problem in that necessary information is missed depending on contents of an event issued as the log. For example, when the packet passing information is issued as the log, pieces of information such as an IP address and a port number are missed in the digest method, and therefore the information useful for the log is considerably decreased. Therefore, it is necessary that an acquisition rate of the log having the large information amount be increased while the use of the device resource is suppressed.

For example, Japanese Patent Publication Laid-Open No. 11-234274 proposes a technique, in which bottleneck analysis is performed on a monitoring target device (agent) side, and traffic is reduced by notifying the monitoring device if needed when a CPU load exceeds a predetermined threshold.

Japanese Patent Publication Laid-Open No. 2004-206495 discloses a technique in which log information is collected while the CPU load on the management device that collects the log is suppressed.

### SUMMARY

According to an aspect of the invention, a log information issuing device includes a priority information manager in which priority information is stored, priority of a log message being defined in the priority information, a message queue that has a plurality of queues for storing the log message according to the priority, a message sorting processor that refers to the priority information to store the log message in the message queue according to the priority, an internal resource information collector that determines a load state of an internal resource from operating information on the internal resource of the log information issuing device, a log message queue processor that takes out the log message from the message queue according to a log obtaining condition, the log obtaining condition defining a condition of the log message that is taken out from the message queue according to the load state, and a log processor that supplies the log message as the log information, the log message being taken out by the log message queue processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a block diagram illustrating a schematic configuration of a log collecting system according to a first embodiment of the invention;

FIG. 2A illustrates an example of a log message format;

FIG. 2B illustrates an example of priority information;

FIG. 3 is a time-series sequence diagram illustrating pieces of processing performed by functional blocks of FIG. 1;

FIG. 4 illustrates a setting example of an upper limit of the number of messages taken out from a log message queue by a log message queue processor;

FIG. 5 is a block diagram illustrating a schematic configuration of a log collecting system according to a second embodiment of the invention;

FIG. 6 is a time-series sequence diagram illustrating pieces of processing performed by functional blocks of FIG. 5;

FIG. 7 illustrates an example of a combination of a log ID and a priority, which are stored as priority information in a log priority information manager;

FIG. 8 illustrates an example of a format of event information in which an event being able to sense generation of a combination of plural log messages is defined from the log messages;

FIG. 9A illustrates an example of the event information;

FIG. 9B illustrates an example of the event information; and

FIG. 9C illustrates an example of the event information.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

However, in the conventional techniques disclosed in Japanese Patent Publication Laid-Open Nos. 11-234274 and 2004-206495, there is a problem in that log information on generation of an accidental failure cannot be collected because only restricted log information is collected in a steady state.

In view of the foregoing, an object of the embodiment is to provide a log information issuing device that can securely and efficiently issue significant log information including a high-priority log message even if a high load is applied on the internal resource while the log having the large information amount can be collected in the steady state.

In accordance with an aspect of the invention, a log information issuing device that issues log information includes a priority information manager in which priority information is stored, priority of a log message being defined in the priority information; a message queue that has plural queues for storing the log message according to the priority; a message sorting processor that refers to the priority information to store the log message in the message queue according to the priority; an internal resource information collector that determines a load state of an internal resource from operating information on the internal resource of the log information issuing device; a log message queue processor that takes out the log message from the message queue according to a log obtaining condition, the log obtaining condition defining a condition of the log message that is taken out from the message queue according to the load state; and a log processor that supplies the log message as the log information, the log message being taken out by the log message queue processor.

In the log information issuing device in accordance with the aspect of the invention, while the log having the larger information amount can be collected in the steady state, the high-priority log message is preferentially supplied even if the high load is applied on the internal resource such as CPU. Therefore, the significant log information including the high-priority log message can securely and efficiently be issued.

In the log information issuing device, the message sorting processor sorts the log message to the plural queues of the message queue according to the priority and stores the message. The message queue processor takes out the log message from the message queue according to the log obtaining condition. The condition of the log message for taking out the log message from the message queue according to the load state is defined in the log obtaining condition. The log processor supplies the taken-out log message as the log information. The output destination of the log information may be another external device, a storage medium provided in the log information issuing device, or a storage medium which may be accessed from the log information issuing device.

Accordingly, in the log information issuing device in accordance with the aspect of the invention, the significant log information can securely and efficiently be issued by preferentially supplying the high-priority log message even if the high load is applied on the internal resource such as CPU, while the log having the large information amount can be collected in the steady state.

In the log information issuing device in accordance with the aspect of the invention, preferably a queue in which a log message having a relatively high priority is stored has a queue length longer than that of a queue in which a log message having a relatively low priority is stored in the message queue. Accordingly, because the log message having the relatively high priority is preferentially stored in the message queue compared to the log message having the relatively low priority, the significant log information can be issued while the loss of the important log message is prevented.

Preferably the log information issuing device in accordance with the aspect of the invention further includes an event information manager in which event information on an event sensed from plural log messages is stored. The event information includes information used to specify the plural log messages for sensing the event and information used to produce an event log concerning the sensed event. The log information issuing device includes an event sensor that senses the generation of the event by comparing the log message taken out by the log message queue processor to the event information and produces the event log concerning the sensed event. The log processor supplies the event log as the log information, the event log being produced by the event sensor. Accordingly, when the event specified by the combination of the plural log messages is detected, the event log expressing the generation of the event is supplied as the log information. Therefore, the complex event generated in the monitoring target device can be recognized.

Preferably the log information issuing device in accordance with the aspect of the invention further includes a log storage in which the log information is at least tentatively stored, wherein the log storage is referred to search residual log messages in the plural log messages for sensing the event when the event sensor senses at least one of the plural log messages for sensing the event by comparing the log message taken out by the log message queue processor to the event information. Accordingly, when at least one of the plural log messages for sensing the event is detected, when another log message for sensing the event is issued in the past, the log message can be detected from the log storage.

In the log information issuing device in accordance with the aspect of the invention, preferably the priority information manager gives increased priority to the residual log messages in the plural log messages for sensing the event when the event sensor senses at least one of the plural log messages for sensing the event by comparing the log message taken out by the log message queue processor to the event information. Accordingly, when one of the plural log messages that become the basis for detecting the generation of the event is detected, a second log message can be prevented from being discarded without taking out the second log message from the message queue by giving the increased priority to the another log message in the plural log messages. Therefore, the generation of the event can securely be detected.

Exemplary embodiments of the invention will be described in detail below with reference to the drawings.

### First Embodiment

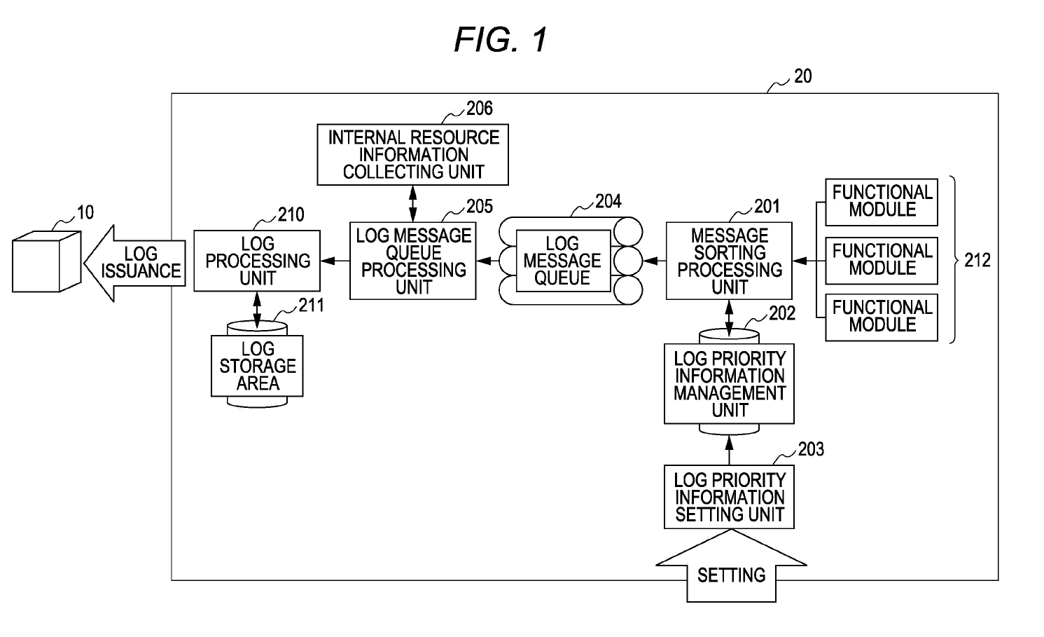

FIG. 1 is a block diagram illustrating a schematic configuration of a log collecting system according to a first embodiment of the invention. As illustrated in FIG. 1, in the first embodiment, a monitoring device 10 collects log information issued from a monitoring target device (log information issuing device) 20.

The monitoring device 10 collects the log information from the monitoring target device 20 to analyze the collected log, and the monitoring device 10 can be implemented as a computer such as a server. Alternatively, the function of the monitoring device 10 may be mounted on a communication terminal device or a communication control device.

The monitoring target device 20 may be implemented as a device having any function as long as the device can issue the operating state of the device or the state of communication with another device as the log information. That is, the monitoring target device 20 may be a data processing device such as a server or a client, a communication terminal device, or a communication control device, and there is no particular limitation to the use or function of the monitoring target device 20.

In order to realize the log processing function, the monitoring target device 20 includes a message sorting processor 201, a log priority information manager 202, a log priority information setter 203, a log message queue 204, a log message queue processor 205, an internal resource information collector 206, a log processor 210, and a log storage unit 211. The functional module 212 of FIG. 1 performs various pieces of processing by utilizing hardware resources such as CPU and a memory in the monitoring target device 20, and the functional module 212 issues a log message including pieces of information such as a processing behavior and an error message.

The message sorting processor 201 receives the log message issued by the functional module 212, and the message sorting processor 201 refers to priority information of the log priority information manager 202 to store each log message in the log message queue 204 according to the priority of the log message.

The log priority information manager 202 stores information defining the priority of the log message therein. The log priority information setter 203 acts as an interface in order that a device manager sets log priority. That is, the device manager feeds a log ID or a priority from the log priority information setter 203 to give the desired priority to each of various log messages, and the device manager stores the priority of the log message in the log priority information manager 202.

The log message queue 204 has plural queues in which the log messages are sorted in each kind of the priority and stored. The log message transmitted from the message sorting processor 201 is stored in the queue according to the priority. For example, in the first embodiment, it is assumed that three stages (high, middle, and low) of priorities are given to the log message. The log message queue 204 has three kinds of queues, that is, a high-priority queue, a middle-priority queue, and a low-priority queue in order to separately store the log messages of the three stages (high, middle, and low) of priorities. In the log message queue 204, a longer queue length is allocated with increasing priority in order to be able to preferentially store the high-priority log message. That is, the high-priority queue has the longest queue length, and the low-priority queue has the shortest queue length.

The log message queue processor 205 determines the kind and the number of log messages taken out from the log message queue 204 according to a load state necessary for the internal resource information collector 206, and the log message queue processor 205 takes out the log message according to the determination result. The log message queue processor 205 transfers the taken-out log message to the log processor 210.

The internal resource information collector 206 periodically collects load information on the resource (such as CPU and memory) involved in the log message processing of the monitoring target device 20. The internal resource information collector 206 distinguishes an additional state of the monitoring target device by the collected load information. For example, various pieces of information such as CPU utilization, memory utilization, and disk utilization can be used as the load information. In the first embodiment, it is assumed that the CPU utilization is used as the load information.

The log processor 210 records the log message in the log storage region 211 while transmitting the log message as the log information (syslog) to the monitoring device 10.

A procedure of the log message processing performed by the above-described configuration will be described below by way of example.

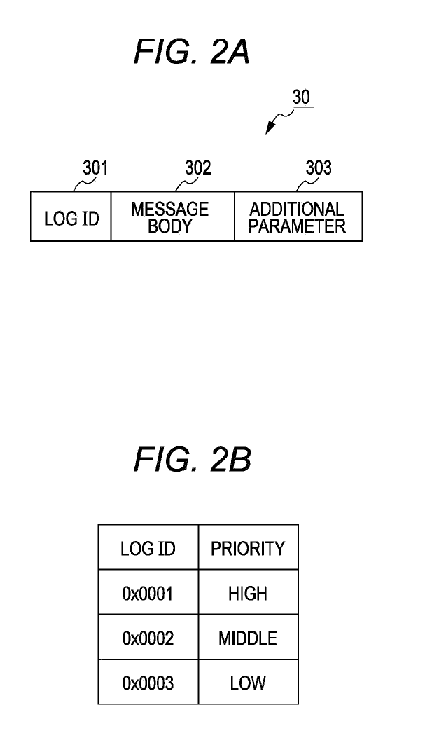

As illustrated in FIG. 2A, it is assumed that a log message 30 issued by the functional module 212 of the first embodiment includes a log ID 301, a message body 301, and an additional parameter 302. The log ID 301 indicates a kind of the log message 30, and the log ID 301 is imparted to each log message according to the kind of the log message when the functional module 212 issues the log message. In the message body 301, the event (such as processing behavior and error message) indicated by the log is described in a predetermined format. The additional parameter 302 is detailed information on the event described in the message body 301.

At this point, it is assumed that the device manager previously sets the priority information of FIG. 2B in the log priority information manager 202 from the log priority information setter 203. The priority information of FIG. 2B is an example in which the monitoring target device 20 is a communication device (for example, router). However, as described above, in the first embodiment, the monitoring target device 20 is not limited to the communication device.

As illustrated in FIG. 2B, the priority information stored in the log priority information manager 202 of the first embodiment includes the log ID and the information indicating a priority level. In the log IDs of FIG. 2B, the log ID 0x0001 is assumed to be imparted to the log message that is issued in cutting off TCP connection. The log ID 0x0002 is assumed to be imparted to the log message that is issued from the functional module 212 when the TCP connection is newly linked up, and the log ID 0x0003 is assumed to be imparted to the log message that is issued from the functional module 212 when the number of TCP connections exceeds a given number. In the first embodiment, only three kinds of log IDs are exemplified for the sake of convenience. However, the log ID is prepared to any log message that can be issued from the functional module 212.

In the example of FIG. 2B, the high priority is given to the log ID 0x0001, the middle priority is given to the log ID 0x0002, and the low priority is given to the log ID 0x0003. That is, in the example of FIG. 2B, the device manager recognizes the log message (cutoff of TCP connection) having the log ID 0x0001 as having a high degree of importance, while the device manager gives higher priority than other log messages to the log message having the log ID 0x0001.For the sake of convenience, the priority levels are described by “high”, “middle”, and “low” in FIG. 2B. However, digital data correlated with each priority level is used in the actual data. As described above, the device manager previously feeds the priority information from the log priority information setter 203.

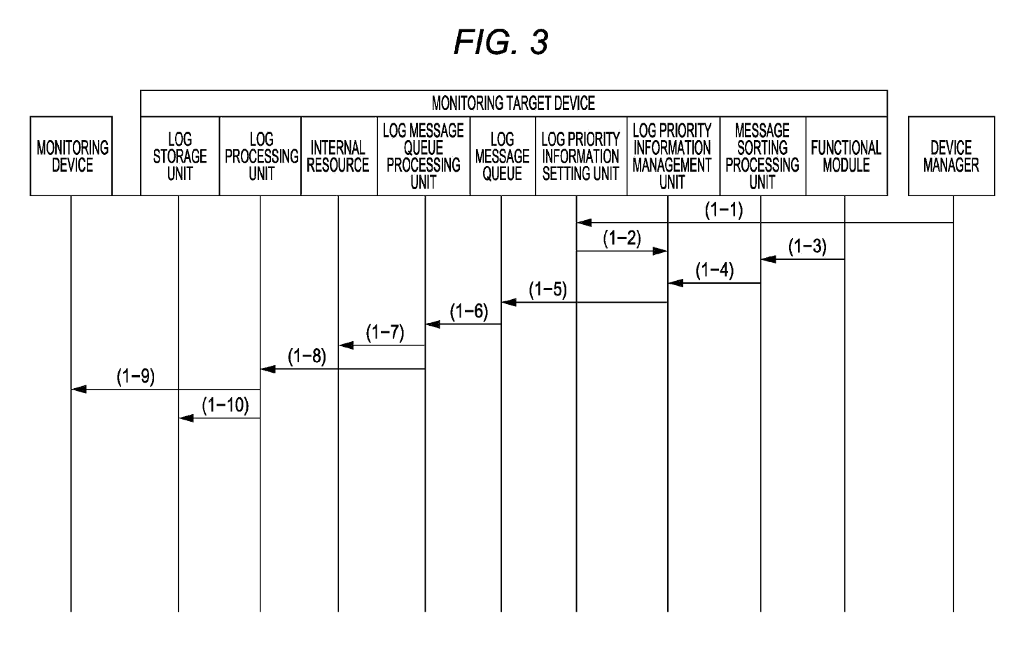

A log message processing procedure will be described with reference to FIG. 3. FIG. 3 is a time-series sequence diagram illustrating pieces of processing performed by the functional blocks of FIG. 1.

Although the time-series sequence diagram of FIG. 3 includes the process (processes (1-1) and (1-2) in FIG. 3) in which the device manager sets the priority information, the processes may be performed at least once in starting the initial use of the monitoring target device 20. That is, when the device manager sets the priority information through the log priority information setter 203 (process (1-1)), the priority information is stored in the log priority information manager 202 (process (1-2)).

When the functional module 212 of the monitoring target device 20 issues the log message, the log message is transferred to the message sorting processor 201 (process (1-3)). The message sorting processor 201 refers to the log priority information manager 202 with the log ID of the transferred log message as a search key, and the message sorting processor 201 obtains the priority information corresponding to the log message (process (1-4)). The message sorting processor 201 stores the transferred log message in the log message queue 204. At this point, the log message is stored in the queue corresponding to the priority that is indicated by the priority information obtained in process (1-4) (process (1-5)). For example, when the functional module 212 issues the log message having the log ID 0x0001 while the priority information of FIG. 2B is stored in the log priority information manager 202, because the log message has the “high” priority, the log message is stored in the queue corresponding to the “high” priority in the log message queue 204.

Then the log message queue processor 205 takes out the log message stored in the log message queue 204 (process (1-6)). At this point, the log message queue processor 205 refers to the internal resource information collector 206 (process (1-7)). In the first embodiment, the internal resource information collector 206 periodically collects the CPU utilization of the monitoring target device 20 to distinguish the load state of the internal resource of the monitoring target device 20 by three stages, that is, a low load, a middle load, and a high load, from the collected CPU utilization.

In processes (1-6) and (1-7), the log message queue processor 205 determines the kind and the number of log messages that should be taken out from the log message queue 204 according to the load state distinguished by the internal resource information collector 206, and the log message queue processor 205 takes out the log message. An upper limit (log obtaining condition) of the number of messages taken out from each of the plural message queues of the log message queue 204 is previously set in the internal resource information collector 206 according to the level of the load state. The upper limit is stored in the internal resource information collector 206 or a memory that is accessible from the internal resource information collector 206. Preferably the internal resource load amounts necessary for the processing for transmitting the log message to the monitoring device 10 and the processing for retaining the log message in the log storage 211 of the monitoring target device 20 are computed, and the upper limit of the number of messages is set such that the CPU utilization does not exceed 100% in performing these pieces of processing.

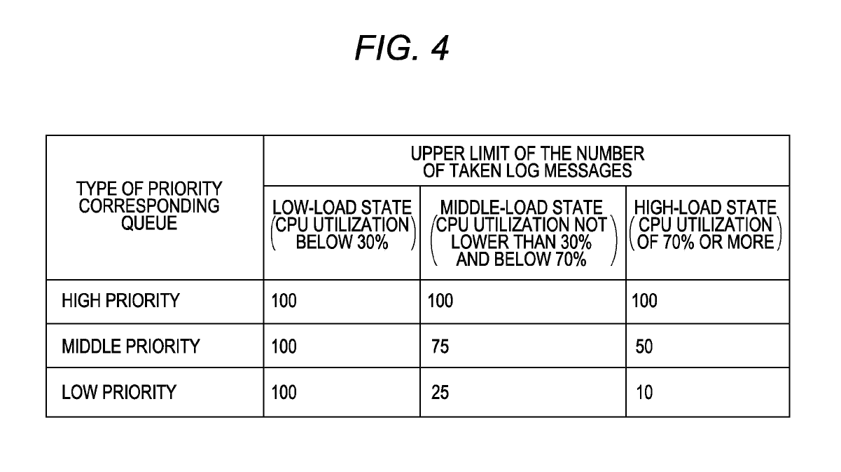

FIG. 4 illustrates a setting example of the upper limit of the number of messages taken out from the log message queue 204 by the log message queue processor 205. In the example of FIG. 4, the state in which the CPU utilization is lower than 30% is defined as a “low load state”, the state in which the CPU utilization is not lower than 30% and lower than 70% is defined as a “middle load state”, and the state in which the CPU utilization is not lower than 70% is defined as a “high load state”. Preferably the upper limit is set such that the high-priority log message is preferentially taken out from the log message queue 204 as the load state of the internal resource of the monitoring target device 20 is raised.

In the first embodiment, as illustrated in FIG. 4, when the load state of the internal resource of the monitoring target device 20 is in the “low load state”, the upper limit of the number of log messages taken out from each of the high-priority queue, middle-priority queue, and low-priority queue of the log message queue 204 is set to 100. When the load state of the internal resource of the monitoring target device 20 is in the “middle load state”, the upper limit is set such that the log messages are taken out up to 100 from the high-priority queue of the log message queue 204, the upper limit is set such that the log messages are taken out up to 75 from the middle-priority queue, and the upper limit is set such that the log messages are taken out up to 25 from the low-priority queue.

When the load state of the internal resource of the monitoring target device 20 is in the “low load state”, the upper limit is set such that the log messages are taken out up to 100 from the high-priority queue of the log message queue 204, the upper limit is set such that the log messages are taken out up to 50 from the middle-priority queue, and the upper limit is set such that the log messages are taken out up to 10 from the low-priority queue. The upper limits of the numbers of log messages are illustrated only by way of example. Thus, the log obtaining condition (the upper limit of the number of log messages taken out from each queue) is set such that the high-priority log message is preferentially taken out in the high load state according to the load state of the internal resource of the monitoring target device 20, so that the log information preferentially including the high-priority log message can be issued even in the high load state.

The log message queue processor 205 transfers the log message taken out from the log message queue 204 to the log processor 210 (process (1-8)). The log processor 210 transmits the log message as the log information to the monitoring device 10 (process (1-9)), and the log processor 210 stores the log message as the log information in the log storage 211 (process (1-10)).

Through the pieces of processing, in the monitoring target device 20 of the first embodiment, the necessary log information can efficiently and securely be issued even in the state in which the high load is applied onto the monitoring target device 20 to suppress the internal resource.

In the related art, because the large amount of log output applies the high load onto the internal resource, it is necessary to restrict the log output or reduce the information amount. However, in the monitoring target device 20 of the first embodiment, the log flow rate is controlled while the priority setting of the log message and the load state monitoring of the internal resource are cooperated with each other, so that the important log information can be collected even if the internal resource of the monitoring target device 20 is in the high load state.

### Second Embodiment

A log collecting system according to a second embodiment will be described below. In the second embodiment, the configuration similar to that of the first embodiment is designated by the same reference numeral as the first embodiment, and the detailed description thereof is not repeated here.

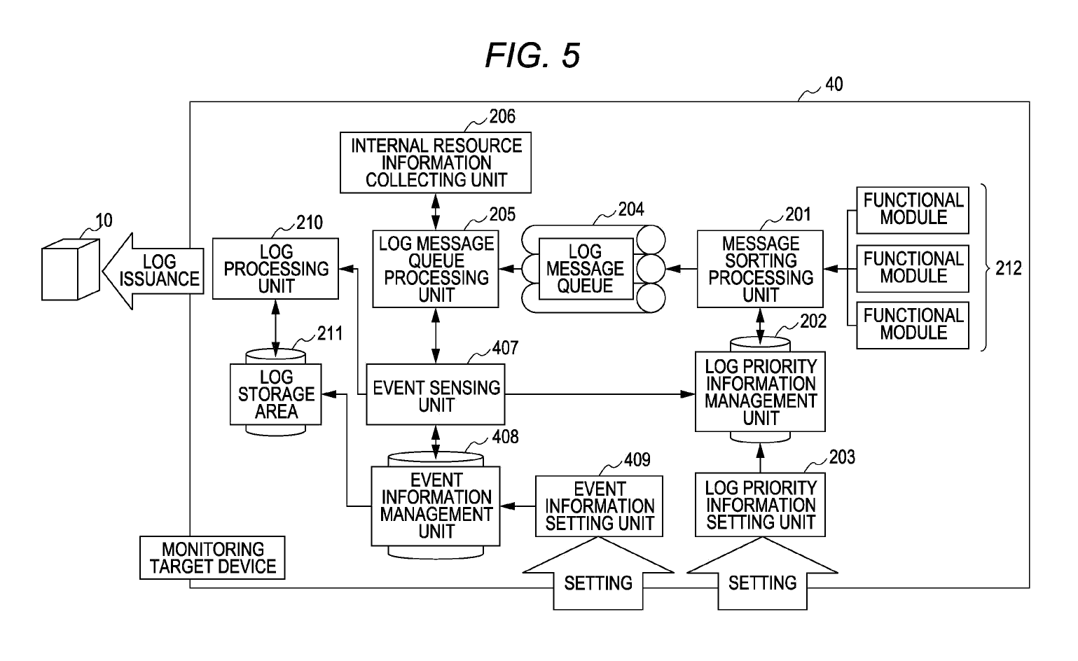

FIG. 5 is a block diagram illustrating a configuration of a log collecting system according to a second embodiment of the invention. As illustrated in FIG. 5, the monitoring target device 40 of the second embodiment differs from the monitoring target device 20 of the first embodiment in that an event sensor 407, an event information manager 408, and an event information setter 409 are additionally provided but other configuration is identical to the first embodiment.

In the second embodiment, the log message queue processor 205 transfers the log message taken out from the log message queue 204 to the event sensor 407 and the log processing module 210.

The event sensor 407 determines whether the log message transferred from the log message queue processor 205 indicates the generation of the predetermined event. In the second embodiment, the “event” means one that can detected from a combination of the plural events. For example, when an event of “cutoff of TCP connection” and an event of “detection of TCP RST packet” are generated within a predetermined time, an event that “connection is cut off by detection of TCP RST packet” can be detected from the combination of the two events.

In the second embodiment, in order to detect such events, the definition (event information) of the event is expressed using the combination of the log messages and stored in the event information manager 408. When monitoring the log messages to detect the combination of the log messages defined in the event information, the event sensor 407 determines that the event is generated, and the event sensor 407 issues the log message (event log) indicating the event generation. Contents of the log message that should be issued as the event log are also defined by the event information.

The event information setter 409 acts as an interface that accepts the setting or a change instruction of the combination of the log messages defining the events from the device manager. The fed event is registered in the event information manager 408.

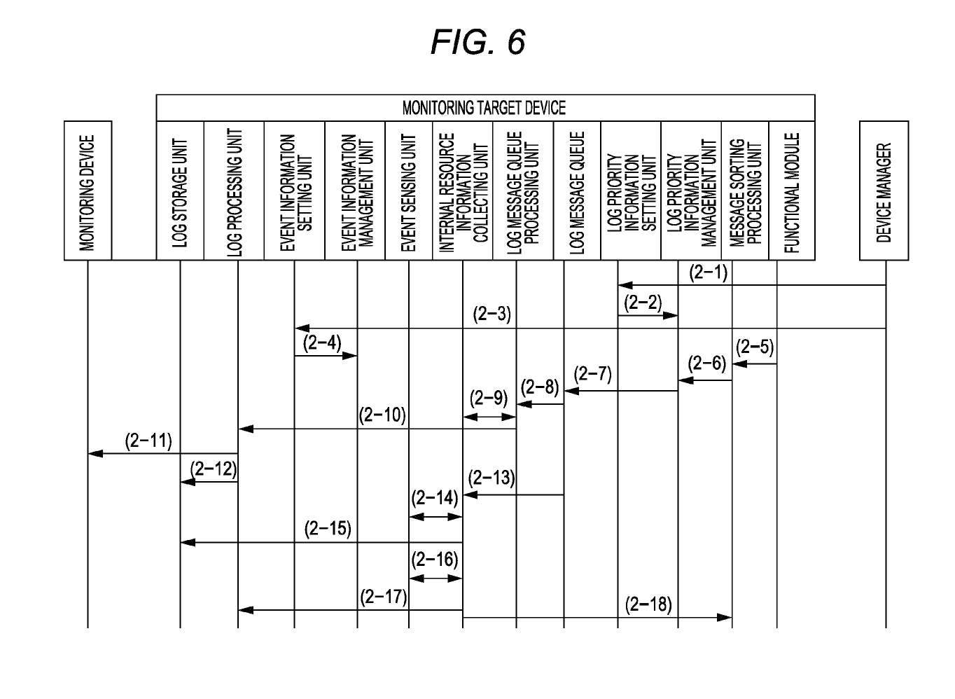

A log message processing procedure will be described with reference to FIG. 6. FIG. 6 is a time-series sequence diagram illustrating pieces of processing performed by the functional blocks of FIG. 5.

Although the time-series sequence diagram of FIG. 6 includes the processes (process (2-1) to process (2-4) in FIG. 6) in which the device manager sets the priority information and the event information, the processes may be performed at least once in starting the initial use of the monitoring target device 40.

When the device manager sets the priority information through the log priority information setter 203 (process (2-1)), the priority information is stored in the log priority information manager 202 (process (2-2)). When the device manager sets the event information through the event information setter 409 (process (2-3)), the event information is stored in the event information manager 408 (process (2-4)).

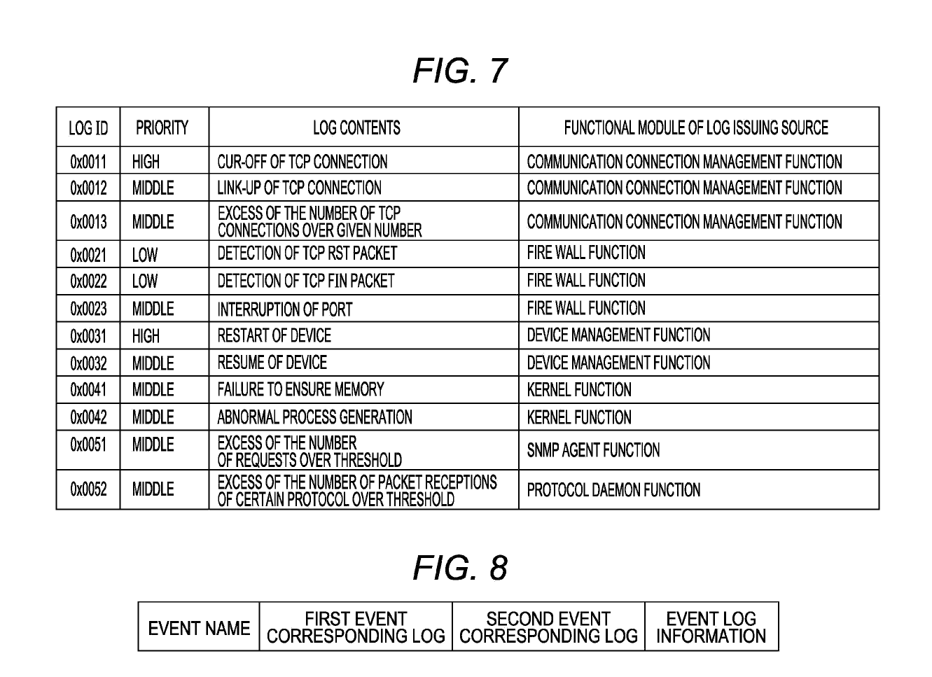

In the second embodiment, it is assumed that the combination of the log ID and priority of FIG. 7 is stored as the priority information in the log priority information manager 202 by the setting of the device manager through the log priority information setter 203. FIG. 7 illustrates the priority, the log contents, and the functional module of the log issuing source in each log ID. However, the pieces of information on the log contents and the functional module of the log issuing source are illustrated in FIG. 7 only for the sake of convenience, and it is not necessary to store the log contents and the functional module of the log issuing source as the priority information in the log priority information manager 202.

That is, in the example of FIG. 7, the functional module having the communication connection management function in the functional modules 212 issues the three kinds of the log message having log IDs 0x0011, 0x0012, and 0x0013. The log message having the log ID 0x0011 indicates that the TCP connection is cut off, and the “high” priority is given to the log message having the log ID 0x0011. The log message having the log ID 0x0012 indicates that the TCP connection is newly linked up, and the “middle” priority is given to the log message having the log ID 0x0012. The log message having the log ID 0x0013 indicates that the number of TCP connections exceeds the predetermined number, and the “low” priority is given to the log message having the log ID 0x0013.

In the functional modules 212, the functional module having a fire wall function issues the log messages having log IDs 0x0021, 0x0022, and 0x0023. The log message having the log ID 0x0021 indicates that a TCP RST packet is detected, and the “low” priority is given to the log message having the log ID 0x0021. The log message having the log ID 0x0022 indicates that a TCP FIN packet is detected, and the “low” priority is given to the log message having the log ID 0x0022. The log message having the log ID 0x0023 indicates that a port is interrupted, and the “middle” priority is given to the log message having the log ID 0x0023.

In the functional modules 212, the functional module having a device management function issues the log messages having log IDs 0x0031 and 0x0032. The log message having the log ID 0x0031 indicates that the monitoring target device 20 is restarted, and the “high” priority is given to the log message having the log ID 0x0031. The log message having the log ID 0x0032 indicates that the monitoring target device 20 is resumed, and the “middle” priority is given to the log message having the log ID 0x0032.

In the functional modules 212, the functional module having a kernel function issues the log messages having log IDs 0x0041 and 0x0042. The log message having the log ID 0x0041 indicates a failure to ensure the memory, and the “middle” priority is given to the log message having the log ID 0x0041. The log message having the log ID 0x0042 indicates that the abnormal process is generated, and the “middle” priority is given to the log message having the log ID 0x0042.

In the functional modules 212, the functional module having an SNMP agent function issues the log message having log ID 0x0051. The log message having the log ID 0x0051 indicates that the number of requests exceeds a threshold, and the “middle” priority is given to the log message having the log ID 0x0051.

In the functional modules 212, the functional module having a protocol daemon function issues the log message having log ID 0x0052. The log message having the log ID 0x0052 indicates that the number of packet receiving times of a certain protocol exceeds a threshold, and the “middle” priority is given to the log message having the log ID 0x0052.

The pieces of priority information of FIG. 7 are illustrated only by way of example. Any priority can be given to the various log messages except for the log messages of FIG. 7.

In the second embodiment, the event information is stored in the event information manager 408 by the setting of the device manager through the event information setter 409. As described above, the event information means the event whose generation can be detected from the combination of the plural log messages. For example, event information of FIG. 8 includes an event name, a combination (first event corresponding log and second event corresponding log) of the log messages for detecting the event, and event generation log information used to issue the event log, as items. The event name may be a name given to the event information or an event ID. The log IDs are set to the first event corresponding log and second event corresponding log. For the event sensed from three or more log messages, items such as a third event corresponding log are added. The log ID of the log message used to report the event generation is set to the event generation log information.

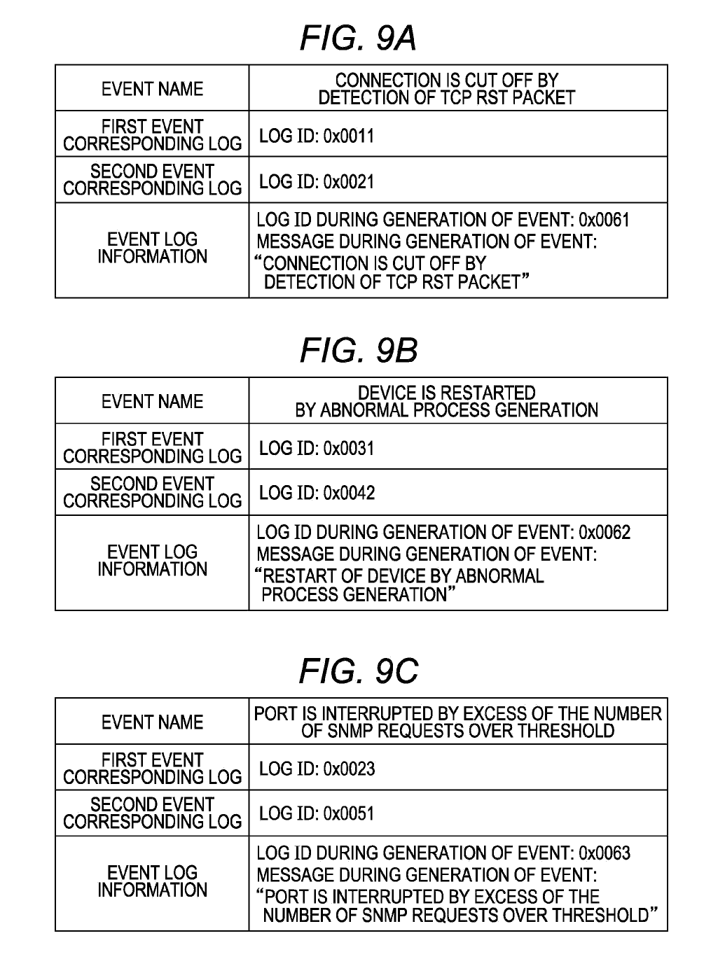

FIGS. 9A to 9C illustrate examples of the event information.

For example, event information of FIG. 9A indicates an event to which the event name of “connection is cut off by detection of TCP RST packet” is given. In the example of FIG. 9A, text information is used as the event name. Alternatively, the event ID may be used instead of the text information. The same holds true for examples of FIGS. 9B and 9C. The log message (cutoff of TCP connection) having the log ID 0x0011 is set to the first event corresponding log, and the log message (detection of TCP RST packet) having the log ID 0x0021 is set to the second event corresponding log. That is, the event sensor 407 determines that the event of “connection is cut off by detection of TCP RST packet” is generated when the log message having the log ID 0x0011 and the log message having the log ID 0x0021 are detected within a predetermined time.

The value of the predetermined time may be stored in a memory that is accessible from the event sensor 407 or defined every event in the event information. In the event information of FIG. 9A, a log ID 0x0061 is set as the event generation log information defining the log message indicating the event generation. The log message having the log ID 0x0061 is defined as the indication of the event of “connection is cut off by detection of TCP RST packet”. That is, the event information of FIG. 9A is used to issue the event log indicating the event generation by determining that the event of “connection is cut off by detection of TCP RST packet” is generated, when the event (cutoff of TCP connection) indicated by the log message having the log ID 0x0011 and the event (detection of TCP RST packet) indicated by the log message having the log ID 0x0021 are generated within the predetermined time.

The event of FIG. 9B indicates an event of “device is restarted by generation of abnormal process”. The log message (device restart) having the log ID 0x0031 is set to the first event corresponding log, and the log message (generation of abnormal process) having the log ID 0x0042 is set to the second event corresponding log. That is, the event sensor 407 determines that the event of “device is restarted by generation of abnormal process” is generated when the log message having the log ID 0x0031 and the log message having the log ID 0x0042 are detected within a predetermined time. In the event information of FIG. 9B, a log ID 0x0062 and a message ID indicating the message of “device is restarted by generation of abnormal process” are set as the event generation log information defining the log message indicating the event generation.

The event of FIG. 9C indicates an event of “port is interrupted by excess of the number of SNMP requests over threshold”. The log message (interrupt of port) having the log ID 0x0023 is set to the first event corresponding log, and the log message (excess of the number of requests over threshold) having the log ID 0x0051 is set to the second event corresponding log. That is, the event sensor 407 determines that the event of “port is interrupted by excess of the number of SNMP requests over threshold” is generated when the log message having the log ID 0x0023 and the log message having the log ID 0x0051 are detected within a predetermined time. In the event information of FIG. 9C, a log ID 0x0063 and a message ID indicating the message of “port is interrupted by excess of the number of SNMP requests over threshold” are defined as the event generation log information defining the log message indicating the event generation.

The pieces of event information are illustrated in FIGS. 9A to 9C only by way of example. An event whose generation is sensed from three or more log messages may be defined.

When the functional module 212 of the monitoring target device 40 issues the log message, the log message is transferred to the message sorting processor 201 (process (2-5)). The message sorting processor 201 refers to the log priority information manager 202 with the log ID of the transferred log message as the search key, and the message sorting processor 201 obtains the priority information corresponding to the log message (process (2-6)). The message sorting processor 201 stores the transferred log message in the log message queue 204. At this point, the log message is stored in the queue corresponding to the priority that is indicated by the priority information obtained in process (2-6) (process (2-7)).

Then the log message queue processor 205 takes out the log message stored in the log message queue 204 (process (2-8)). At this point, the log message queue processor 205 refers to the load state of the internal resource of the monitoring target device 40 (process (2-9)). The load state of the internal resource of the monitoring target device 40 is distinguished by the internal resource information collector 206.

In processes (2-8) and (2-9), the log message queue processor 205 determines the kind and the number of log messages that should be taken out from the log message queue 204 according to the load state distinguished by the internal resource information collector 206, and takes out the log message. The upper limit of the number of messages taken out from each of the plural message queues of the log message queue 204 is previously set to the internal resource information collector 206 according to the level of the load state.

The log message queue processor 205 transfers the log message taken out from the log message queue 204 to the log processor 210 (process (2-10)). The log processor 210 stores the log message in the log storage 211 while transmitting the log message as the log information to the monitoring device 10 (process (2-11)) (process (2-12)).

In parallel with the process (2-9), the log message queue processor 205 transfers the log message obtained from the log message queue 204 to the event sensor 407 (process (2-13)). The event sensor 407 refers to the event information manager 408 with the log ID of the log message as the search key to search whether there is the log ID matched with the item of the first event corresponding log of the event information (process (2-14)). When the event information including the log ID is registered in the item of the first event corresponding log, the event sensor 407 obtains the log ID set to the item of the second event corresponding log of the event information. For example, when the log ID 0x0011 is used as the search key, the log ID 0x0021 set to the item of the second event corresponding log is obtained as the log ID that becomes paired with the log ID in the event information from the event information (see FIG. 8A) including the log ID in the item of the first event corresponding log.

When the log ID set to the item of the second event corresponding log is obtained, the event sensor 407 searches the log storage 211 to determine whether the log message having the obtained log ID is issued in the past (process (2-15)). When the log message having the obtained log ID is issued in the past, the event sensor 407 determines that the event is detected, and the event information manager 408 obtains the event generation log information set in the event information by referring to the event information corresponding to the detected event (process (2-16)). As described above, because the log ID of the log message (event log) issued in detecting the event is set to the event generation log information, the event sensor 407 obtains the log ID to transfer the log ID to the log processor 210. The log processor 210 issues the log message (event log) according to the log ID.

In the process (2-15), when the log ID set to the item of the second event corresponding log is not detected from the log storage 211, the event sensor 407 then monitors whether the log message having the log ID is issued. In such cases, the event sensor 407 performs the processing for raising the priority of the log message having the log ID such that the log message having the log ID is not discarded by the control of the log flow rate. The event sensor 407 refers to the log priority information manager 202 (process (2-18)), and the event sensor 407 searches the priority information on the log message. At this point, the priority information on the log ID 0x0021 is rewritten from “low” to “high”. When one of two log messages is issued after the other log message for detecting the event is detected, one of the log messages can be detected more securely through the processing.

In the second embodiment, the event of the combination of the logs can be detected by the pieces of processing. For example, only the generation of the event of “cutoff of TCP connection” is recognized by the log message having the log ID 0x0011 of FIG. 7. However, in the second embodiment, for example, the event detected from the combination of the log message having the log ID 0x0011 and the log message having the log ID 0x0021 is indicated by the individual log message (event log) having the log ID 0x0061, so that the detection of the TCP RST packet is found to be the cause of the cutoff of the connection to recognize the detailed information on the cause.

For example, in the example of FIG. 9B, only the generation of the event of “device restart” is recognized by the log message having the log ID 0x0031. However, the event detected from the combination of the log message having the log ID 0x0031 and the log message having the log ID 0x0042 is indicated by the individual log message (event log) having the log ID 0x0062, so that the generation of the abnormal process is found to be the cause of the device restart to obtain the information useful to analyze the cause of the restart.

For example, in the example of FIG. 9C, only the generation of the event of “interrupt of port” is recognized by the log message having the log ID 0x0023. However, the event detected from the combination of the log message having the log ID 0x0023 and the log message having the log ID 0x0051 is indicated by the log message (event log) having the log ID 0x0063, so that the excess of the number of SNMP requests over threshold is found to be the cause of the interrupt of port to learn the bottom cause of the interrupt of port, and therefore the effective countermeasure can be taken.

Thus, in the monitoring target device 40 of the second embodiment, when the event found from the combination of the plural log messages is detected, the event log indicating the event generation is issued as the log information, so that the complex event generated in the monitoring target device 40 can be recognized. When one of the plural log messages based on the detection of the event generation is detected, priority of another log message in the plural log messages is raised. Therefore, another log message is prevented from being discarded without taking out another log message from the message queue 204, so that the event generation can securely be detected.

Although the first and second embodiments are exemplified, the invention is not limited to the embodiment and modifications thereof, and various changes can be made without departing from the scope of the invention.

For example, in the first and second embodiments, the monitoring target devices 20 and 40 issue the log information to the monitoring device 10. Alternatively, each of the monitoring target devices 20 and 40 may be provided in a stand-alone mode, or the log information may be stored in the internal storage medium thereof (log storage 211).

In the first and second embodiments, the monitoring target device (log information issuing device) is mainly described as an example. Alternatively, as described in the embodiments, the log information issuing device may be performed by the method for issuing the log information in the monitoring target devices 20 and 40 and the control program for causing the monitoring target devices 20 and 40 to issue the log information.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A log information issuing device that issues log information, comprising:
a priority information manager in which priority information is stored, a priority of a log message being defined in the priority information;
a message queue that has a plurality of queues for storing the log message according to the priority;
a message sorting processor that refers to the priority information to store the log message in the message queue according to the priority;
an internal resource information collector that determines a load state of an internal resource from operating information on the internal resource of the log information issuing device;
a log message queue processor that takes out the log message from the message queue according to a log obtaining condition, the log obtaining condition defining a condition of the log message that is taken out from the message queue according to the load state; and
a log processor that supplies the log message as the log information, the log message being taken out by the log message queue processor.

2. The log information issuing device according to claim 1, wherein a queue in which a log message having a relatively high priority is stored has a queue length longer than that of a queue in which a log message having a relatively low priority is stored in the message queue.

3. The log information issuing device according to claim 1, further comprising:
an event information manager in which event information on an event sensed from a plurality of log messages is stored, the event information including information used to specify the plurality of log messages for sensing the event and information used to produce an event log concerning the sensed event; and
an event sensor that senses the generation of the event by comparing the log message taken out by the log message queue processor to the event information and produces the event log concerning the sensed event,
wherein the log processor supplies the event log as the log information, the event log being produced by the event sensor.

4. The log information issuing device according to claim 3, further comprising a log storage in which the log information is at least tentatively stored,
wherein the log storage is referred to search residual log messages in the plurality of log messages for sensing the event when the event sensor senses at least one of the plurality of log messages for sensing the event by comparing the log message taken out by the log message queue processor to the event information.

5. The log information issuing device according to claim 3, wherein the priority information manager gives increased priority to the residual log messages in the plurality of log messages for sensing the event when the event sensor senses at least one of the plurality of log messages for sensing the event by comparing the log message taken out by the log message queue processor to the event information.

6. A log information issuing method performed by a log information issuing device, the log information issuing method comprising the steps of:
storing priority information in a priority information manager, a priority of a log message being defined in the priority information;
referring to the priority information to store the log message in a message queue according to the priority, the message queue having a plurality of queues for storing the log message according to the priority;
determining a load state of an internal resource from operating information on the internal resource of the log information issuing device;
taking out the log message from the message queue according to a log obtaining condition, the log obtaining condition defining a condition of the log message that is taken out from the message queue according to the load state; and
supplying the log message as the log information, the log message being taken out from the message queue.

7. A program that causes a log information issuing device to perform processing for issuing log information, the program causing the log information issuing device to perform the steps of:
storing priority information in a priority information manager, a priority of a log message being defined in the priority information;
referring to the priority information to store the log message in a message queue according to the priority, the message queue having a plurality of queues for storing the log message according to the priority;
determining a load state of an internal resource from operating information on the internal resource of the log information issuing device;
taking out the log message from the message queue according to a log obtaining condition, the log obtaining condition defining a condition of the log message that is taken out from the message queue according to the load state; and
supplying the log message as the log information, the log message being taken out from the message queue.
